(19) United States
(12) Patent Application Publication
(10) Pub. No.: US 2012/0272168 A1
(43) Pub. Date: Oct. 25, 2012

(54) METHODS, APPARATUS, AND SYSTEMS FOR VISUALLY REPRESENTING A RELATIVE RELEVANCE OF CONTENT ELEMENTS TO AN ATTRACTOR

(75) Inventors: Margaret Withgott, Los Altos, CA (US); Christian W.W. Halvorsen, Los Altos, CA (US); Sarah Queen Browning, Los Altos, CA (US)

(73) Assignee: Panafold, Los Altos, CA (US)

(21) Appl. No.: 13/090,526

(22) Filed: Apr. 20, 2011

(51) Int. Cl. G06F 3/14

(52) U.S. Cl. 715/763; 715/762

(57) ABSTRACT

Relationships between content elements and an attractor may be visually displayed on a page. More specifically, the relevance of one or more characteristics of the content elements to one or more attributes of the attractor may be depicted by organizing the attractor and the content elements on a page so that a relative vector between the attractor and the content elements as arranged on the page is related (in a meaningful fashion) to said relevance. Content elements may be selected from one or more sources and/or may be included in a feed of content elements. In some cases, a characteristic of an attractor may be transmitted to a plurality of vendor systems and one or more of the vendor systems may return (or cause to be returned) a message in response thereto.

### FIELD OF THE INVENTION

The present invention relates to methods, apparatus, and systems for visually displaying relationships between an attractor and content elements.

### BACKGROUND

Content elements are traditionally displayed in lists, such as lists of search results, contact names, or file names. These lists may be linearly organized according to various criteria, such as in an order defined by letters of the alphabet, creation date, and/or authorship. However, displaying information in this way fails to convey any meaningful information regarding the relationship of content elements to one another or to a search criterion, etc. Thus, a user cannot readily understand or appreciate a more nuanced relationship between the content elements themselves and the content elements and the search criterion without reference to other information.

### SUMMARY

Systems, apparatus, and methods, for visually representing a relative relevance of content elements to an attractor are herein presented.

In one embodiment of the invention, a page is displayed on a display device of a processor-based apparatus, such as a computer monitor, a touchscreen, a television, or a display unit of mobile phone. The display device may be communicatively coupled to the processor of the processor-based apparatus and the page may include an array of content elements. The content elements may be displayed on the page as, for example, graphical elements, images, alphanumeric terms or phrases, and/or icons. In some instances, combinations of these displayed representations of the content items may occupy the same page. These content elements may represent, for example, search results, contacts (e.g., identifying information regarding individuals known by a user or viewer of the page), e-mails, messages, products, news articles, jobs, opportunities, candidates, matches provided by an online dating service, service providers, locations, individuals, organizations, vendors, etc. The display device may be enabled to directly receive user input and/or an instruction via, for example, a touch and/or a gesture.

User input specifying a characteristic of an attractor may be received and, on some occasions, an icon or other display element representing the attractor may be displayed on the page. Exemplary characteristics include a search request, an attribute, a search term, an employment qualification, a personal quality, a Boolean search term, and a binary search term. A relevance of each content element to the characteristic of the attractor may be determined. In some cases, the user input specifying a characteristic of an attractor may be received when the user, for example, purchases access to the characteristic/attractor, accesses the characteristic/attractor via a remote server, downloads the characteristic/attractor, and/or associates the characteristic with the attractor via an attractor generation process.

A visual representation of the attractor and a repositioning of the content elements may be displayed on the page such that a relative displacement or vector between the visual representation of the attractor and each element is related to the determined relevance of each respective content element. In some embodiments, the relative displacement or vector between the visual representation of the attractor and each element may be proportional to the determined relevance of each respective content element. On some occasions, the page may be displayed as a three-dimensional page and the vector between the attractor and the content element may be displayed in two or three Cartesian or other dimensions.

In addition to (or in lieu of) the above, in some cases a degree of similarity between two or more content elements may be determined and the relative vector may further account for the determined degree of similarity between different ones of the content elements. In one instance, when the at least two content elements have a threshold degree of similarity with one another, the content elements may be displayed on the page at least partially superimposed on one another. The representation of the first content element may be rendered as partially transparent in order to allow the representation of the second content element to be seen, or, alternatively, the first content element may be rendered opaquely in order to prevent the representation of the second content element from being seen. In other cases, the different representations of the different content elements may be toggled on and off so as to permit viewing of both content elements on the page. The rate at which the toggling occurs may be selected in order to accommodate desired viewing characteristics and/or other display effects. In some cases, when characteristics of at least two content elements have a threshold degree of similarity, the visual representation of the content elements may be displayed on a different region of the surface area of a three-dimensional object such as a side of a cube or a hemisphere of a sphere.

When an instruction to reposition a location on the attractor on the page is received (e.g., by way of the aforementioned gesture or other means), the location on the attractor on the page may be repositioned accordingly. The processor may determine an updated relative vector for each content element and as the location on the attractor on the page is changed, the processor may issue instructions to likewise update the locations of the content elements on the page according to, for example, the updated values of the relative vectors therefor. This may affect the positions of the displayed representations of the content elements, with the overall effect being similar to dragging a magnet (embodied as the attractor) in proximity to magnetic materials, like iron filings (embodied as the content elements) and having those materials reorient themselves in relation to the magnet accordingly. This kind of familiar metaphor provides the viewer of the page with a ready reference for understanding the relationships between the characteristic of the attractor and the content elements, and also the interrelationships therebetween.

In one embodiment, the content elements may be provided for display on the page by a content element provider, and the visual representations of the content elements may displayed only upon receipt of an indication that the content element provider has determined that the user has sufficient subscription rights to view the content elements. When no indication that the content element provider has determined that the user has sufficient subscription rights to view the content elements has been received, an interface configured to permit the user to acquire subscription rights sufficient to view the content elements may be displayed to the user.

In another embodiment, user input specifying a characteristic of one or more additional attractors may be received and a relevance of each content element to the characteristic of the additional attractors may be determined. A visual representation of the additional attractor may be displayed on the page and the visual representations of the content elements may be repositioned on the page such that a relative vector between the visual representations original and the additional attractors and the visual representation of each content element is related to the determined relevance of each respective content element.

The content elements may represent data received via a feed, for example, a feed from a server. Such content elements may be displayed on a first location on the page when received and a degree of relevance for each content element to the characteristic of the attractor may be determined. The content elements may then be moved, over time, from the first location on the page to a second location on the page. Content elements with a threshold degree of relevance to the characteristic of the attractor may be positioned on the page near an icon or other graphical representation of the attractor and removed from the feed of content elements moving to the second location on the page. Each content element not positioned near the attractor from the page may then be removed from the page when it reaches the second location on the page.

In a further embodiment, systems, apparatus, and methods for transmitting a message to a user are herein provided. A characteristic of an attractor may be received from a user associated with a user account and a message indicating the attractor may be transmitted to a plurality of vendor or merchant systems. In response, a message related to the characteristic of the attractor may be received from one or more of the vendor systems (or a related system, such as an ad service subscribed to be the vendor associated with the vendor system) and transmitted to the user via the user account.

Exemplary non-transitory computer-readable media provided herein may include a set of instructions which, when executed by a processor, enable the processor to perform operations implementing the herein-described procedures. Likewise, computer systems or other data processing apparatus provided herein which include a processor and a display device communicatively coupled to one another may be configured to implement the herein-described processes.

These and further embodiments of the invention are discussed in greater detail below.

### BRIEF DESCRIPTION OF THE DRAWINGS

The present application is illustrated by way of example, and not limitation, in the figures of the accompanying drawings, in which:

FIG. 1 illustrates an example of a system having elements configured to visually display relationships between an attractor and one or more content elements in accordance with embodiments of the present invention;

FIG. 2 illustrates an example of a computer system configured for use in a system such as that depicted in FIG. 1 in accordance with embodiments of the present invention;

FIGS. 3-5 illustrate exemplary interface pages, in accordance with embodiments of the present invention;

FIG. 6A illustrates an example of a page including an array of content elements in accordance with embodiments of the present invention;

FIG. 6B illustrates an example of a page including an array of repositioned content elements in accordance with embodiments of the present invention;

FIG. 7A illustrates an example of a page including a stream of content elements in accordance with embodiments of the present invention;

FIG. 7B illustrates an example of a page including a stream of repositioned content elements in accordance with embodiments of the present invention;

FIG. 8 is a flowchart illustrating an exemplary process for repositioning content elements displayed on the page in accordance with embodiments of the present invention;

FIG. 9 is a flowchart illustrating an exemplary process for repositioning content elements included in a stream of content elements in accordance with embodiments of the present invention; and

FIG. 10 is a flowchart illustrating an exemplary process for transmitting a message to a user in accordance with embodiments of the present invention.

Throughout the drawings, the same reference numerals and characters, unless otherwise stated, are used to denote like features, elements, components, or portions of the illustrated embodiments. Moreover, while the subject invention will now be described in detail with reference to the drawings, the description is done in connection with the illustrative embodiments. It is intended that changes and modifications can be made to the described embodiments without departing from the true scope and spirit of the subject invention as defined by the appended claims.

### DETAILED DESCRIPTION

Embodiments of the present invention involve the display of visual representations of content elements received by a computer system in an organized relation to an attractor that is also displayed on the display device at a position subject to user manipulation through a human-computer interface communicatively coupled to the processor. The organized relation is defined by a relevance of an attribute of the content elements to a characteristic of the attractor. The effect can be manifest in any of several ways, for example, as a magnet (the attractor) that attracts or repels (to varying degrees) magnetic objects like iron filings (the content elements), or as pebbles (the attractors) in a stream of content elements, which cluster around the pebbles according to their relevance to a term or other attribute defined by the attractor. Visual depictions that mimic these familiar metaphors allow users to readily grasp relationships between attributes defined by the attractors and characteristics of interest of the content elements (as well as between the content elements themselves), even if those relationships are complex in nature. Accordingly, users are able to make more informed decisions regarding the content elements and/or their use thereof or reliance thereon.

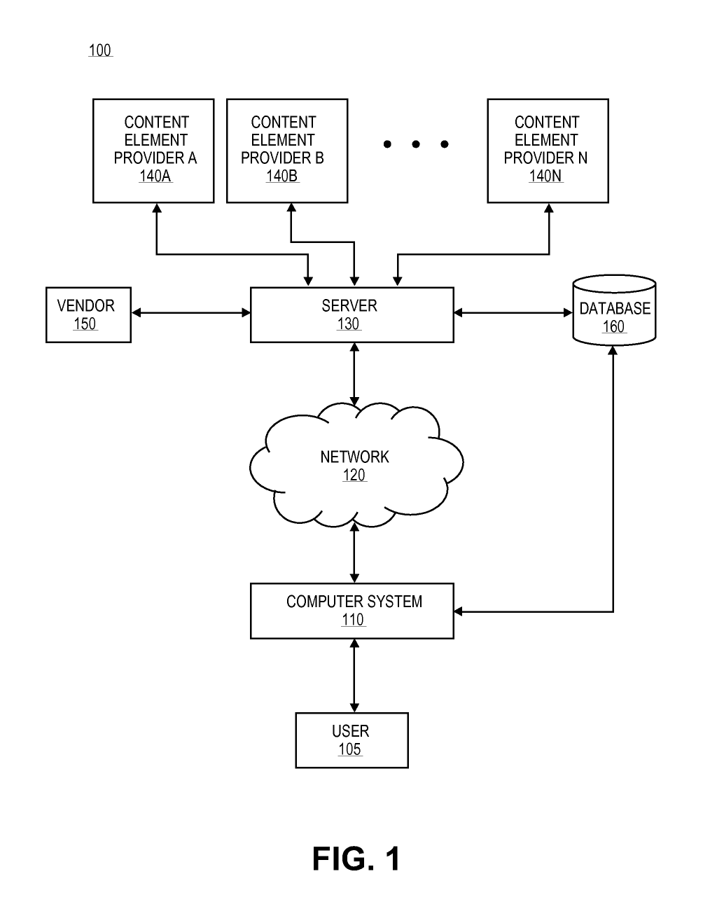

Referring first to FIG. 1, an example of a system 100 including elements thereof configured to visually display relationships between an attractor and one or more content elements is depicted. A user 105 interacts with system 100 via computer system 110 (the user's computer system), which is communicatively coupled to a server 130 via a network 120. Server 130 is communicatively coupled to a plurality of content element providers 140A-N. Although only one server 130 is illustrated, it should be appreciated that this one server may represent many servers, arranged in central or distributed fashion, for example, such servers may be organized as a central cloud and/or may be distributed geographically or logically to edges of a system such as a content delivery network or other arrangement.

Computer system 110 may be any computer system enabled to execute the methodologies described herein, such as, a personal computer (PC), a tablet computer (e.g., an iPad™), a mobile communication device (e.g., a BlackBerry™, or iPhone™, etc.), and/or a portable computer system (such as a laptop computer, etc.). Computer system 110 may be communicatively coupled to server 130 via network 120 using, for example, a wired or wireless connection to a modem or similar equipment that couples computer system 110 to network 120 in order to exchange data therewith, and, in turn, delivers data to computer system 110 from server 130. Network 120 may be any network enabling communication between computer system 110 and server 130 and/or content element providers 140A-N, such as the Internet, a local area network (LAN), a wireless local area network (WLAN), and/or any other appropriate network.

Computer system 110 may be enabled to receive one or more instructions for executing one or more of the methodologies described herein from user 105 via, for example, a communication interface that is configured to receive commands via one or more customary human-computer interface elements such as a keyboard, joystick, mouse, touch pad, touch screen, etc. On some occasions, computer system 110 may receive an instruction to access and/or search for one or more content elements stored, for example, internally and/or in content element providers 140A-N. Content elements may be collected or channeled by server 130 from one more content element providers 140A-140N at/through a server 130 and may be delivered from server 130 to computer system 110 via network 120. Exemplary content element providers 140A-140N include websites and databases.

In one embodiment, the content elements may be provided for display on the page by a content element provider, and the visual representations of the content elements may displayed only upon receipt of an indication that the content element provider has determined that the user has sufficient subscription rights to view the content elements. When no indication that the content element provider has determined that the user has sufficient subscription rights to view the content elements has been received, an interface configured to permit the user to acquire subscription rights sufficient to view the content elements may be displayed to the user. For example, when a content element provider 140A-140N is associated with a news organization, the news organization may charge a fee for access to news content elements it provides in a manner similar to, for example, a newspaper subscription. On some occasions, a subscription right may be granted based on an attribute of the user. For example, a content element provider 140A-140N may grant a user subscription rights to access content elements regardless of whether a fee is paid based on, for example, an attribute of the user (e.g., geographic location, membership in an organization or status as a student).

Optionally, a vendor system 150 may be communicatively coupled to server 130. Vendor system 150 may be a computer system (or systems) associated with any merchant or seller of goods or services, including an occasional seller of goods or services or an individual or organization offering a good or service (e.g., a volunteer or social organization). Vendor system 150 may be configured to receive a characteristic of an attractor from computer system 110 and transmit a message to computer system 110 in response thereto. Vendor systems may include or be associated with ad servers operated by the vendors or by third parties, in which case the vendor system may relay information to the ad server which allows the as server to respond (either to the vendor system or directly to computer system 110) with one or more messages.

Optionally, a data store 160 may be communicatively coupled to server 130 and/or computer system 110. Data store 160 may be enabled to store data associated with, for example, user 105 and/or one or more content element providers 140A-140N. Data store 160 may be any data storage device, combination of data storage devices, and/or database enabled to store, for example, previously generated attractors, templates that may be used to generate an attractor, content elements, repositioned arrays of content elements, and/or subscription information.

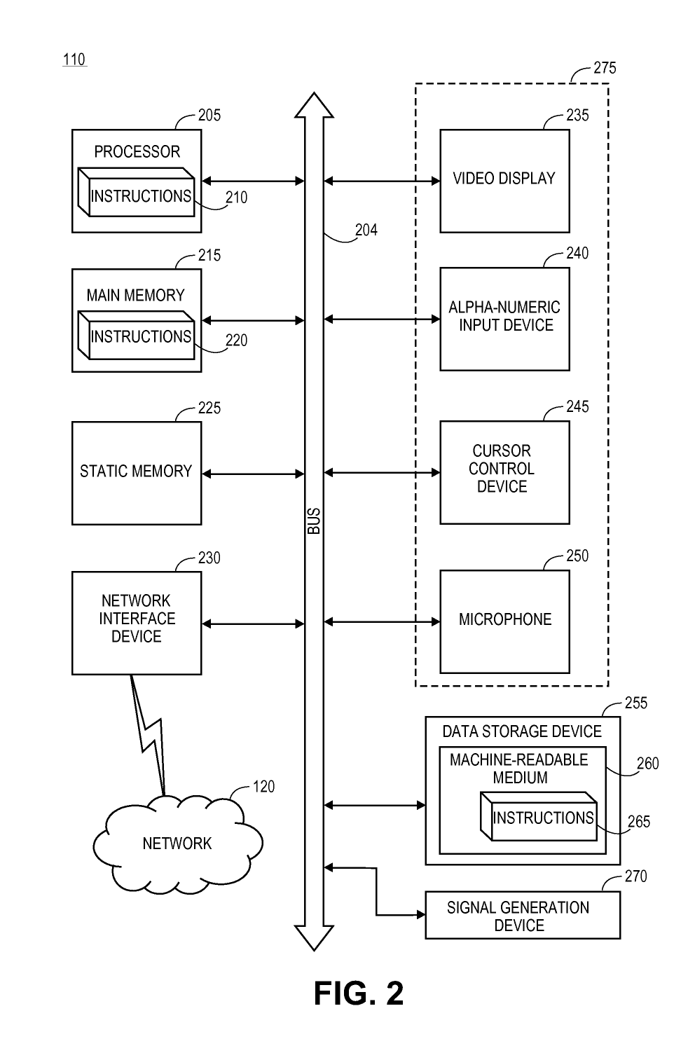

FIG. 2 is a block diagram illustrating one example of a computer system 110 within which a set of instructions 210, 220, and 265 for causing computer system 110 to perform any one or more of the methodologies discussed herein, may be executed. In this example, components of computer system 110 are coupled directly, or indirectly, to a communication bus 204, although in other cases layers of busses or, indeed, different busses or other communication paths may be used to communicatively couple the various components of this device. Therefore, it should be appreciated that the example shown in FIG. 2 is intended only as one possible computer system configuration and is not intended to limit the scope of the present invention in any way.

In alternative embodiments, computer system 110 operates as a standalone device or may be connected (e.g., network 120) to other machines. In a network deployment, computer system 110 may operate in the capacity of a client machine in a server-client network environment, or as a peer machine in a peer-to-peer (or distributed) network environment.

Computer system 110 includes a network interface device 230 coupled to bus 204. Network interface device 230 provides a two-way data communication path with server 130. For example, network interface device 230 may be a wired or wireless local area network (LAN) interface to provide a data communication connection to a compatible LAN (such as a LAN that uses an IEEE 802.11a/b/g/n communication protocol). Computer system 110 can send messages and receive data, sets of instructions, and/or content elements through network interface device 230.

Computer system 110 also includes a processor 205 (e.g., a central processing unit (CPU), a graphics processing unit (GPU), or both), a main memory 215 (e.g., read-only memory (ROM), flash memory, dynamic random access memory (DRAM) such as synchronous DRAM (SDRAM) or Rambus DRAM (RDRAM), etc.), and a static memory 225 (e.g., flash memory, static random access memory (SRAM), etc.), which communicate with each other via a bus 204 or other communication mechanism for communicating information.

Computer system 110 may further include a video display 235 (e.g., a liquid crystal display (LCD) or a cathode ray tube (CRT)). In some cases video display 235 may be enabled to directly receive user input via, for example, touches or gestures (e.g., a pressure-sensitive touchscreen or capacitive touchscreen). Computer system 110 also includes a communication interface 275 via which a user, such as user 105, may communicate with computer system 110. For example, communication interface 275 may include an alpha-numeric input device 340 (e.g., a keyboard or a virtual keypad rendered on a touchscreen), a cursor control device 345 (e.g., a mouse, joystick, or trackpad), a microphone 250, and/or video display 235, in cases where video display 235 is enabled to directly receive user input. In some embodiments, computer system 110 may include a signal generation device 270 (e.g., a speaker or transmitter) for generating a signal, such as an audio signal for transmission to user 105.

Computer system 110 may further include a data storage device 255 and RAM 215 for storing, for example, one or more content elements, attractor characteristics, repositioned arrangements of content elements, and/or repositioned arrangements of a stream of content elements. Data storage device 255 may include a non-transitory machine-readable storage medium 260 on which is stored one or more sets of instructions 265 (e.g., software) embodying any one or more of the methodologies or functions described herein. Set of instructions 265 as well as the content elements, attractor characteristics, repositioned arrangements of content elements, and/or repositioned arrangements of a stream of content elements may also reside, completely or partially, within main memory 215 and/or within processor 205 during execution of various operations by computer system 110. In some embodiments, static memory 225 and processor 205 may also constitute non-transitory machine-readable storage media (at least in part). Set of instructions 265 may be compatible with, for example, one or more of the following operating systems; iOS™ as operable on, for example, an iPhone™ or iPad™, Android™, Windows Mobile™, Blackberry™, Nokia/Symbian™, and Java™-based systems. In some cases, set of instructions 265 may be transmitted or received over a network 120 via network interface device 230 as, for example, a software application as available via an online marketplace (e.g., Apple's App Store™, iTunes™, and/or the Android Marketplace™). In alternative embodiments, hard-wired circuitry may be used in place of, or in combination with, set of instructions 265 to implement the invention. Thus, embodiments of the invention are not limited to any specific combination of hardware circuitry and software.

While set of instructions 265 are shown in an exemplary embodiment to be on a single medium, the term “non-transitory machine-readable storage medium” should be taken to include a single medium or multiple media (e.g., a centralized or distributed database or data source and/or associated caches and servers) that store the one or more sets of instructions 265. The term “non-transitory machine-readable storage medium” shall also be taken to include any non-transitory medium that is capable of storing, encoding, or carrying a set of instructions for execution by computer system 110 and that cause computer system 110 to perform any one or more of the methodologies of the present invention. The term “non-transitory machine-readable storage medium” shall accordingly be taken to include, but not be limited to, solid-state memories, optical media, and magnetic media.

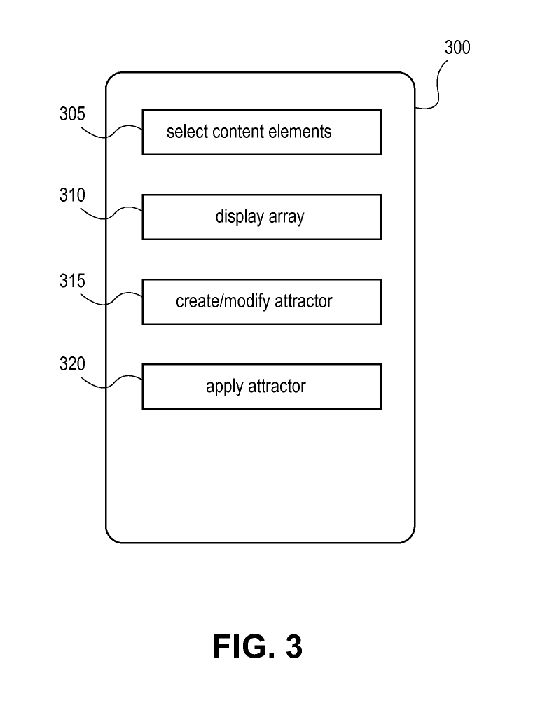

The interface pages depicted in FIGS. 3-7B may be displayed on a user's computer system, such as computer system 110, via, for example, a software application downloaded to and/or installed on the computer system, such as set of instructions 265. It should be understood that the term “page” refers to any type of display including one or more content elements and an attractor. For example, a page may be represented in two or three Cartesian dimensions and may have finite, or infinite, boarders.

FIG. 3 is a block diagram illustrating an exemplary interface page 300 (which may, in some cases, be rendered as a graphical user interface (GUI)) that enables a user to execute one or more of the processes described herein. GUI page 300 may be displayed via, for example, a video display like video display 235 of computer system 110 and may include a plurality of buttons that may be activated by a user, such as user 105, via any conventional means (e.g., positioning and invoking a cursor or touching a corresponding area of a touchscreen). For example, GUI page 300 includes a select content elements button 305, a display array button 310, a create/modify attractor button 315, and an apply attractor button 320. Although illustrated as buttons, the functions invoked via this interface (and the others discussed herein) may be represented in any convenient fashion, for example buttons, icons, pull down menu commands, or other computer interface elements known in the art.

Activation of select content elements button 305 allows a user to select one or more content elements via, for example, a search and/or browsing operation. The selected content elements may be stored, for example, internally or externally to computer system 110. Exemplary content elements include search results generated by, for example, a search engine, information received via a social media service, songs, files, messages, images, documents, contacts, news articles, jobs, candidates, matches provided by an online dating service, opportunities, products, service providers, locations, individuals, organizations, vendors, search results, email messages, messages received via a social networking service (e.g., Facebook™ or Twitter™), audio files video files, files downloaded from the Internet and/or any combination thereof.

Activation of display array button 310 allows a user to transmit an instruction to the processor to prepare and/or provide a display of an array of one or content elements. On some occasions, the content elements included in the displayed array are selected via activation of select content elements button 305. On other occasions, the content elements included in the displayed array are selected by, for example, default or user defined criteria.

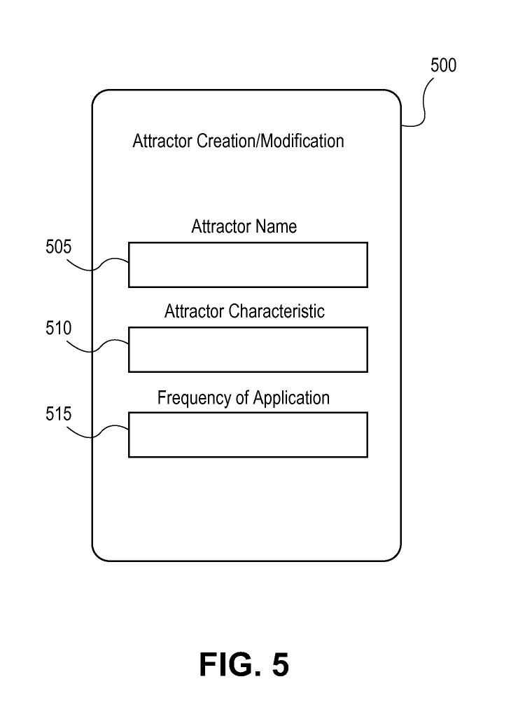

Activation of create/modify attractor button 315 may enable a user to transmit an instruction to the processor to create and/or modify an attractor. In one embodiment, activation of create/modify attractor button 315 may initiate display of an interface page, such as interface page 500 of FIG. 5, in which a user may enter and/or modify information relating to an attractor.

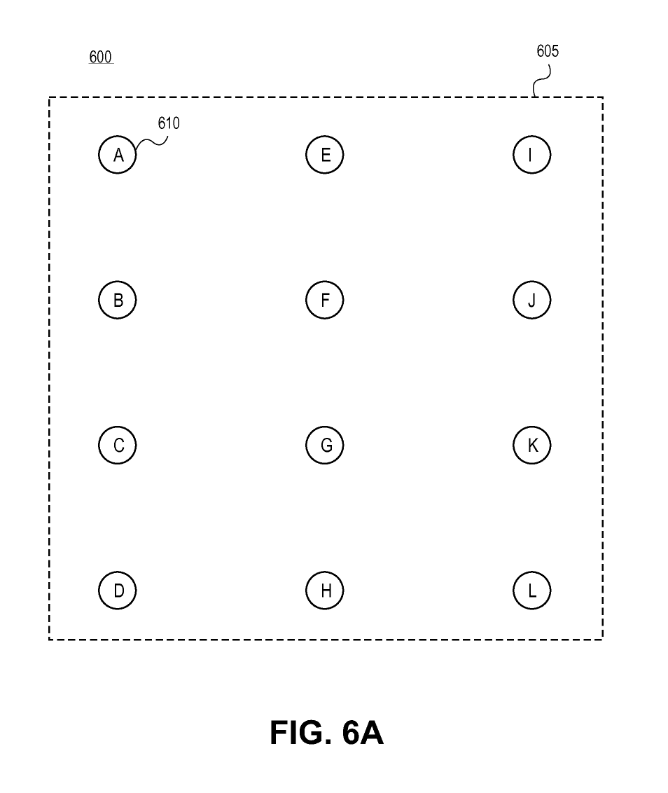

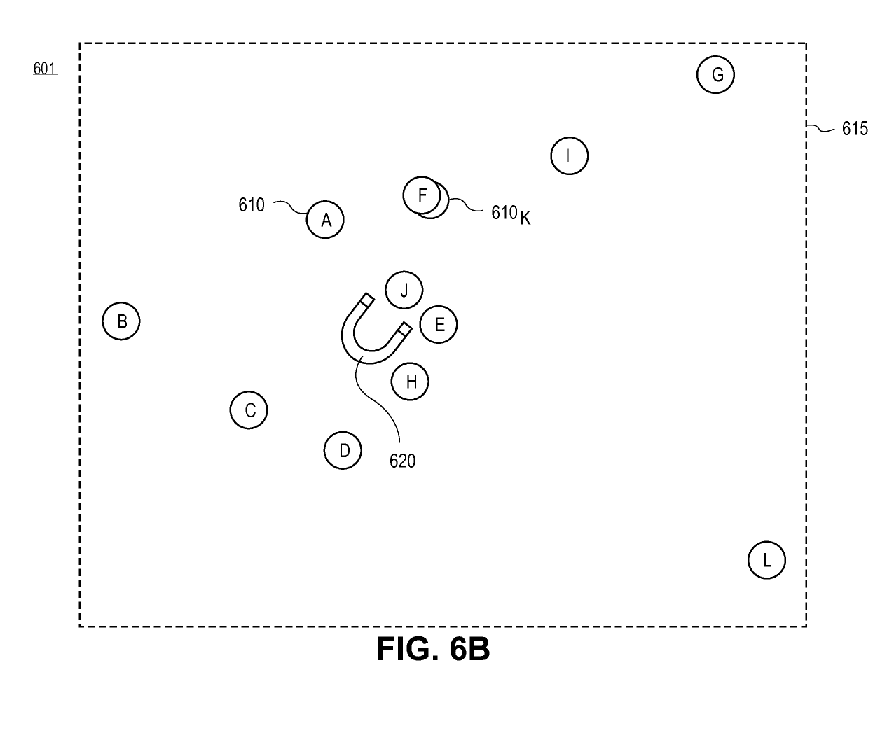

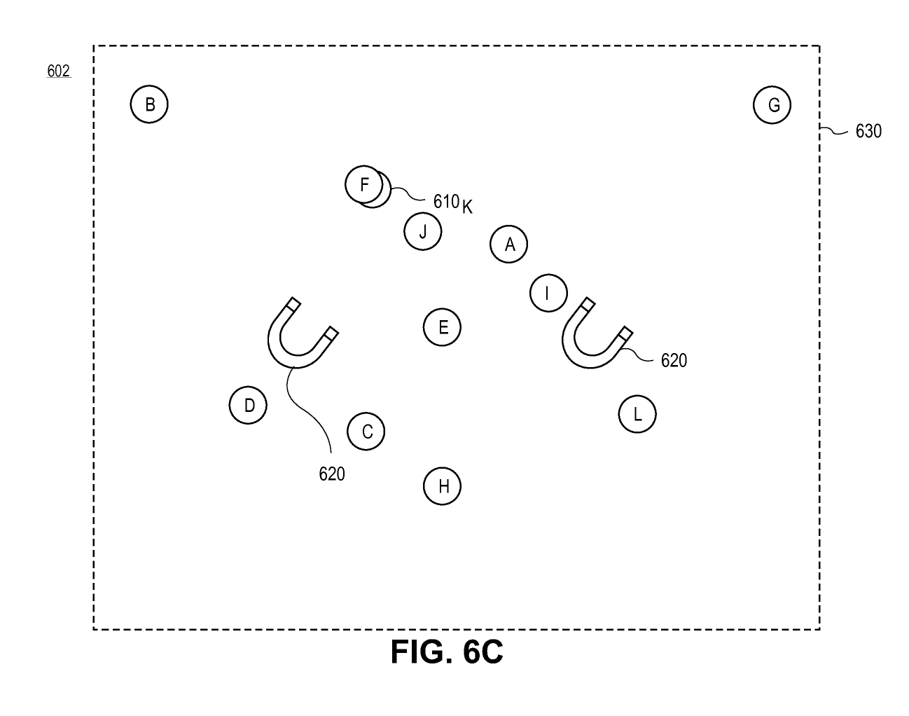

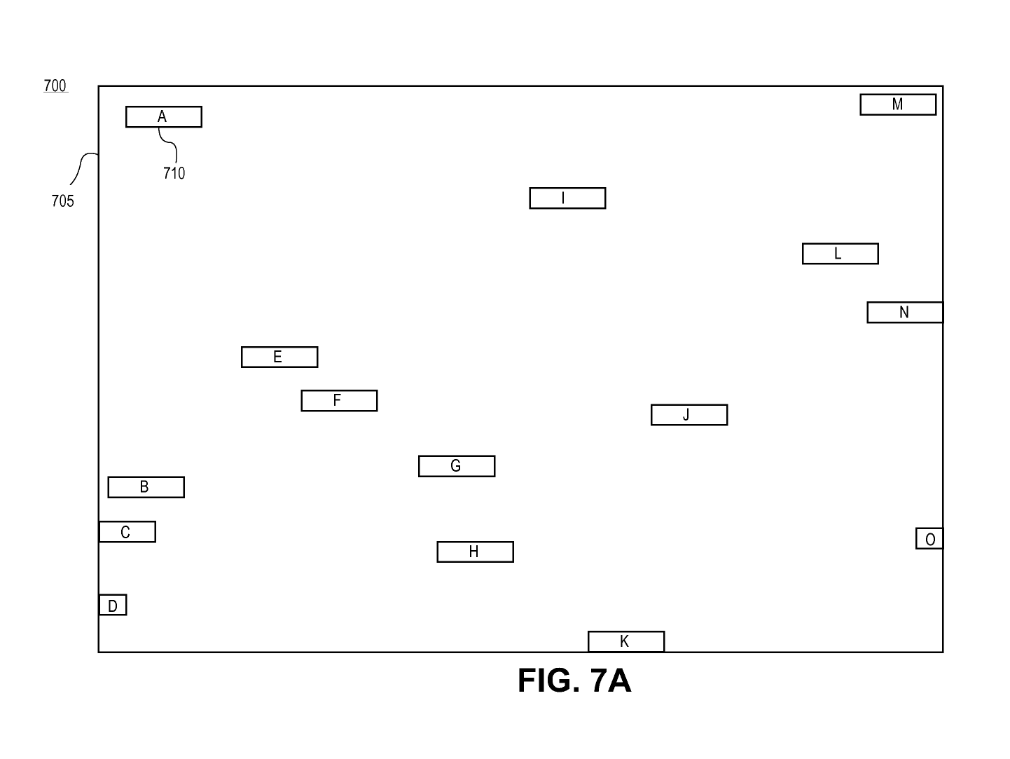

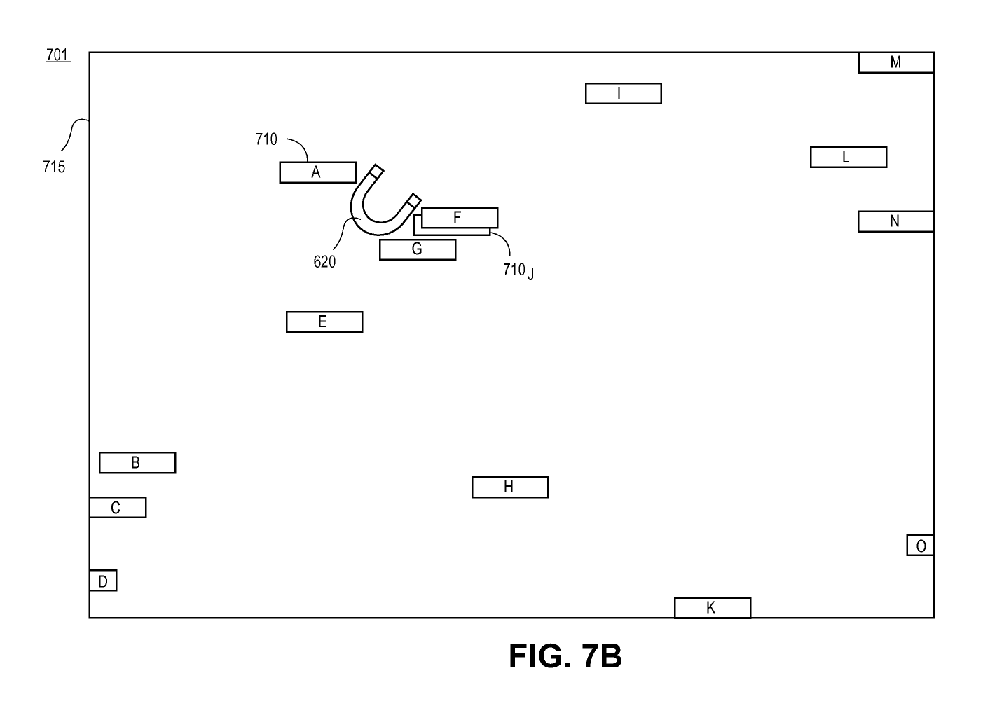

Activation of apply attractor button 320 may enable a user to transmit an instruction to the processor to add an icon representing an attractor to an array of content elements and/or reposition content elements included in an array in response to application of one or more attractors to the array as shown in FIGS. 6B and 7B. On some occasions, the content elements may be repositioned so that a relative distance or vector between the icon representing the attractor and individual content elements is proportional or otherwise related to a relevance of each respective content element to the applied attractor. In some instances, the content elements to which the attractor is applied may be selected via activation of select content elements button 305.

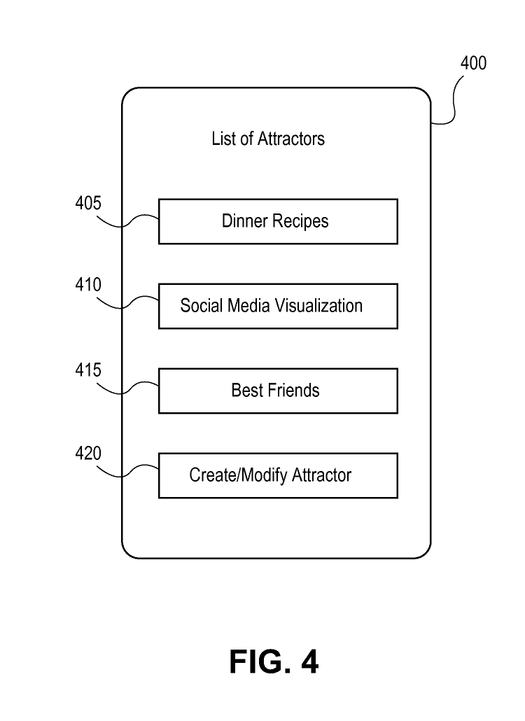

FIG. 4 is a block diagram illustrating an exemplary interface page 400 including a list of previously generated attractors that enables a user to execute one or more of the processes described herein. Interface page 400 may be displayed via, for example, a video display like video display 235 of computer system 110 and may include a plurality of buttons that may be activated by a user, such as user 105, via any conventional means (e.g., positioning and invoking a cursor or touching a corresponding area of a touchscreen). For example, interface page 400 includes a plurality of previously generated attractors, such as a “dinner recipes” attractor button 405, a “social media visualization” attractor button 410, and a “best friends” attractor button 415. The interface page may also include and a create/modify attractor button 420.

Activation of any of the previously generated attractors may enable a user to, for example, transmit an instruction to the processor to, for example, access information regarding the previously generated attractor, apply a previously generated attractor to an array of content elements and/or view a page with content elements positioned relative to one or more of the activated previously generated attractors.

Activation of create/modify attractor button 420 may enable a user to transmit an instruction to the processor to, for example, create a new attractor and/or modify a previously generated, or existing, attractor. In some cases, create/modify attractor button 420 may be similar to create/modify attractor button 315. In one embodiment, activation of create/modify attractor button 420 may initiate display of an interface page 500, as shown in FIG. 5, in which a user may enter and/or modify information relating to an attractor.

In some embodiments, a user may generate and/or download one or more of the previously generated attractors included in page 400. Previously generated attractors may be downloaded from, for example, a website, a server like server 130, a content element provider like content element provider 140A-140N, and/or a friend's computer. In some cases, a subscription right may be required and/or a fee may be charged for the downloading of a previously generated attractor. On some occasions, a subscription right may be granted based on an attribute of the user. For example, a user's geographic location, membership in an organization, or status as a student may be sufficient to grant the user a subscription right to access a previously generated attractor regardless of whether a fee is paid. On other occasions, a user may be provided an opportunity to purchase subscription rights sufficient to view and/or use a previously generated attractor via any conventionally available means.

FIG. 5 is a block diagram illustrating an exemplary interface page 500 including an attractor creation and/or modification menu that enables a user to execute one or more of the processes described herein. Interface page 500 may be displayed via, for example, a video display like video display 235 of computer system 110 and may include a plurality of buttons that may be activated by a user, such as user 105, via any conventional means (e.g., positioning and invoking a cursor or touching a corresponding area of a touchscreen).

Interface page 500 includes a plurality of data entry boxes that enable a user to create and/or modify an attractor. For example, a user may select a characteristic from a list of characteristics associated with a data entry box via, for example, a drop down list of options and/or enter, paste, and/or type, information into one or more of the data entry boxes of interface page 500.

By way of example and not limitation, interface page 500 includes an attractor name data entry box 505, an attractor characteristic data entry box 510, and a frequency of application data entry box 515. A user may enter, select, and/or modify a name of an attractor via attractor name data entry box 505.

A user may enter, select, and/or modify a characteristic of an attractor via attractor characteristic data entry box 510. Entered characteristics may used to, for example, attract and/or repel content elements. Exemplary characteristics include a type of a content element (e.g., a news article, a song, a contact, a friend, or file type), a date (e.g., a day, time, or year), an attribute (e.g., content element size or security protocol attached to content element), a source (e.g., website, feed, email, or list of contacts), and a search characteristic (e.g., search term or keyword). In the case of an attractor with multiple characteristics, a user may also set a priority, or order, in which each of the characteristics may be applied to content elements. In some embodiments, an attractor may be generated and/or modified to attract alert notices, such as emergency notices (e.g., in the event of a natural disaster like a forest fire or earth quake), traffic notices, weather notices, sports notices, and/or breaking news notices.

A frequency with which the created and/or modified attractor may be applied to content elements may be entered, selected, and/or modified by activation of data entry box 515. For example, an attractor may be applied to content elements on a one-time, periodic, random, pseudo-random, and/or as needed basis.

FIG. 6A is a block diagram illustrating an exemplary page 600 on which an array 605 of content elements 610_{A-L} is displayed via, for example, a video display like video display 235 of computer system 110. Although array 605 contains a finite number of content elements displayed in a two-dimensional grid array, it should be understood that array 605 may include any number of content elements displayed in any fashion.

On some occasions, page 600 may include one or more elements of interface pages 300-500 (not shown). For example, page 600 may include select content elements button 310, display array button 310, create/modify attractor button 315, apply attractor button 320, create/modify attractor button 420, and/or a plurality of previously generated attractors. Content elements may be displayed as, for example, graphical elements, images, alpha-numeric characters, and/or icons.

Content elements 610_{A-L} displayed in array 605 may be, for example, a default set of content elements and/or may be selected from a source of content elements by, for example, a user, such as user 105, via, for example, interface page 300 and/or any conventional means. On some occasions, content elements 610_{A-L} may be selected from data stored on and/or received via, for example, computer system 110 and/or content element providers 140A-140N.

In some cases, a subscription right may be required and/or a fee may be charged in order to access to one or more content elements 610_{A-L}. On some occasions, a subscription right may be granted based on an attribute of the user. For example, a user's membership in an organization or status as a student may be sufficient to grant the user a subscription right to access content elements 610_{A-L} regardless of whether a fee is paid. On other occasions, a user may be provided an opportunity to purchase subscription rights sufficient to access and/or view content elements 610_{A-L} via any conventionally available means.

Exemplary content elements 610_{A-L} include search results generated by, for example, a search engine, information received via a social media service (e.g., Facebook™ or Twitter™), songs, files, messages, images, documents, contacts, news articles, products, service providers, locations, individuals, organizations, jobs, candidates, matches provided by an online dating service, opportunities, vendors, search results, email messages, audio files, video files, files downloaded from the Internet, and/or any combination thereof.

FIG. 6B is a block diagram illustrating an exemplary page 601 on which an array 615 of repositioned content elements 610_{A-L} is displayed via, for example, a video display like video display 235 of computer system 110. Page 601 may also include an attractor icon 620 that may be created and/or modified via, for example, interface pages 300-500 and/or processes 800-1000 as discussed herein with regard to FIGS. 3-5 and 8-10, respectively.

Repositioned content elements 610_{A-L} may be arranged within array 615 such that a relative distance or vector between an individual content element 610_{A-L} and attractor 620 is proportional or otherwise related to a relevance of the individual content element 610_{A-L} to a characteristic associated with attractor 620. For example, when a characteristic associated with attractor 620 is dinner recipes, as with attractor 405, as discussed above with regard to FIG. 4, content elements 610_{A-L} may be analyzed to determine their individual relevance to one or more characteristics associated with dinner recipe attractor 620. Content elements 610_{A-L} may then be repositioned within array 615 such that a relative distance or vector between attractor 620 and each content element 610_{A-L} is proportional to the determined relevance of each respective content element 610_{A-L} to the one or more characteristics associated with attractor 620. For example, content elements 610_{J}, 610_{E}, and 610_{H} may be recipes directly relevant to a “dinner” characteristic as defined by a user defining attractor 620 while content elements 610_{A}, 610_{B}, 610_{C}, 610_{D}, 610_{F}, and 610_{K} may be recipes moderately or indirectly relevant to the “dinner” characteristic and the remaining content elements may have little or no relevance to the “dinner” characteristic. In some cases, attractor 620 may act to repel content elements that have little or no relevance to a characteristic associated with attractor 620 or when a characteristic of attractor 620 specifically repels content elements associated with the characteristic. Content elements 610_{G} and 610_{L} are examples of content elements that may be repelled by attractor 620.

On some occasions, the repositioning of content elements in Cartesian directions relative to attractor 620 may further indicate an individual content element's relevance to one or more characteristics associated with attractor 620. On some occasions, a content element's relevance to a first characteristic may be indicated by a distance or vector between the content element and attractor 620 in a first direction, the content element's relevance to a second characteristic may be indicated by a distance or vector between the content element and attractor 620 in a second direction and the content element's relevance to a third characteristic may be indicated a distance or vector between the content element and attractor 620 in a third direction, where the first, second and third directions are oriented orthogonal to one another. In other instances, rotational and distance directions may be employed and in still further cases, other vectors may define such relevances.

In one embodiment, two or more content elements may be compared with one another and content elements that, for example, are substantially similar to one another or share a characteristic that is the same may be repositioned such that a first content element 610_{F} is partially superimposed on a substantially similar content element 610_{K} so that content element 610_{K} is partially obscured as displayed on page 601 by content element 610_{F}. In this way, substantially similar content elements may appear to be stacked or layered on top of one another. The order of content elements within the stack may be determined by, for example, default and/or user configured parameter. For example, substantially similar content elements may be stacked such that the most recently opened, created, and/or saved content element is positioned on top of the stack. In any stacking arrangement, the representation of one content element may be rendered as partially transparent in order to allow the representation of another content element to be seen, or, alternatively, the first content element may be rendered opaquely in order to prevent the representation of the second content element from being seen. In other cases, the different representations of the different content elements may be toggled on and off so as to permit viewing of both content elements on the page. The rate at which the toggling occurs may be selected in order to accommodate desired viewing characteristics and/or other display effects.

FIG. 6C is a block diagram illustrating an exemplary page 602 on which an array 630 of repositioned content elements 610_{A-L} is displayed via, for example, a video display like video display 235 of computer system 110. Page 602 may also include two attractor icons 620_{A} and 620_{B} that may be created and/or modified via, for example, interface pages 300-500 and/or processes 800-1000 as discussed herein with regard to FIGS. 3-5 and 8-10, respectively.

Repositioned content elements 610_{A-L} may be arranged within array 630 such that a relative distance or vector between an individual content element 610_{A-L} and one or both attractors 620_{A} and 620₈ are proportional or otherwise related to a relevance of the individual content element 610_{A-L} to a characteristic associated with attractor 620_{A} and/or 620_{B}, respectively.

In some embodiments, characteristics associated with attractors 620_{A} and/or 620_{E} may act as, for example, Boolean operators (e.g., “and,” “or,” and “not”), plain language search terms, and/or keyword search terms on the content elements. For example, when a characteristic associated with attractor 620_{A} is dinner recipes, as with attractor 405, as discussed above with regard to FIG. 4, and a characteristic of attractor 620₈ is French food recipes, content elements 610_{A-L} may be analyzed to determine their individual relevance to one or more characteristics associated with dinner recipe attractor 620_{A} and French food recipe attractor 620_{B}. Content elements 610_{A-L} may then be repositioned within array 630 such that a relative distance or vector between attractors 620_{A} and 620_{E} and each content element 610_{A-L} is proportional to the determined relevance of each respective content element 610_{A-L} to the one or more characteristics associated with attractors 620_{A} and 620_{E} (e.g., a recipe relevant to both the dinner characteristics of attractor 620_{A} and French food recipes of attractor 620_{B}). For example, content elements 610_{J}, 610_{E}, and 610_{H} may be recipes directly relevant to a “dinner” characteristic as defined by a user defining attractor 620_{A} and a “French food” characteristic as defined by a user defining attractor 620_{B}. Within the same example, content elements 610_{D}, 610_{c}, 610_{F}, and 610_{K} may be content elements more relevant to the “dinner” characteristic of attractor 620_{A} than the “French food” characteristic of attractor 620_{E} (hence their positioning closer to attractor 620_{A} than attractor 620_{B} within array 630). Likewise, content elements 610_{A}, 610_{I}, and 610_{L} may be content elements more relevant to the “French food” characteristic of attractor 620_{E} than the “dinner” characteristic of attractor 620_{A} (hence their positioning closer to attractor 620_{E} than attractor 620_{A} within array 630). In some cases, attractors 620_{A} and/or 620_{E} may act to repel content elements that have little or no relevance to a characteristic associated with attractors 620_{A} and/or 620_{B}, respectively, or when a characteristic of attractor 620_{A} and/or 620_{B} specifically repels content elements associated with the characteristic. Content element 610_{G} is an example a content element that is repelled by both attractor 620_{A} and 620_{B}, although it is repelled more strongly by 620_{A} and therefore is positioned within array 630 closer to attractor 620_{B} than attractor 620_{A}. Likewise, content element 610_{B} is an example a content element that is repelled by both attractor 620_{A} and 620_{B}, although it is repelled more strongly by 620_{B} and therefore is positioned within array 630 closer to attractor 620_{A} than attractor 620_{B}.

FIG. 7A is a block diagram illustrating an exemplary page 700 on which a stream 705 of content elements 710_{A-O} received via a feed (e.g., a continuous or other feed) is displayed via, for example, a video display like video display 235 of computer system 110. Although stream 705 contains a finite number of content elements displayed in two-dimensions, it should be understood that stream 705 may include any number of content elements displayed in any fashion.

A feed may be any continuously and/or contemporaneously received stream of content elements. Exemplary feeds include a news feed, a social media feed (e.g., from a source such as Facebook™ or Twitter™), an email feed, and a financial information feed (e.g., stock prices or options trading).

When a content element 710_{A-O} is received via the feed, it may be displayed at a first location on page 700 and then moved, over time, from the first location on page 700 to a second location on page 700. For example, when a content element such as content element 710_{D} is received, it may be displayed at a location on the left hand side page 700. Over time, content element 710_{D} may increase in size (e.g., 170_{c} and 710_{B}) and move across the page to the right side page 700. When a content element reaches the second location on page 700, it may be partially and/or totally removed from stream 705 and/or page 700 (e.g., 170_{N} and 710_{O}). Content elements 710_{A-O} may move across page 700 at the same rate and/or at different rates relative to one another. Thus, the effect is like a stream of content items flowing across the page from right to left (or, in other cases, left to right, top to bottom, bottom to top, middle to edge, edge to middle, etc.)

FIG. 7B is a block diagram illustrating an exemplary page 701 on which a stream 715 of content elements 710_{A-O} received via a feed is repositioned in response to application of attractor 620. Exemplary page 701 may be displayed via, for example, a video display, like video display 235 of computer system 110. Although array 715 contains a finite number of content elements, it should be understood that array 715 may include any number of content elements displayed in any fashion.

In FIG. 7B, attractor 620 has been applied to stream 715 such that content elements 710_{A-O} with a threshold degree of relevance to a characteristic of attractor 620 are removed from stream 715 moving across page 700 and are positioned near attractor 620 (e.g., content elements 710_{A}, 710_{G}, 710_{F}, and 710ⱼ) and may be removed from the stream of content elements moving across page 701. Content elements that do not have a threshold degree of relevance to a characteristic of attractor 620 may continue to move across page 701 (e.g., content elements 710_{H}, 710_{I}, 710_{K}, 710_{L}, and 710_{M}), reach the second location on page 701 (e.g., content element 710_{N}), and be removed from stream 715 (e.g., content element 710_{O}). Thus, the effect is similar to that of pebbles in a stream collecting content items around them according to the various relevances of a topic or other characteristic represented by the pebble to an attribute of the content item.

In some embodiments, an attractor may operate in a manner that is unseen to a user as, for example, a background function, so that the attractor attracts content elements, for example, continuously, periodically, randomly, or pseudo randomly while, for example, a user is using a device on which the attractor is operating for a different purpose. Content elements attracted in this manner may be stored in, for example, memory 225, main memory 215, a remote data store, such as data store 160, or on a remote server, such as server 130. A page showing content elements attracted in this way may be displayed, for example, upon request by a user via, for example, selecting an icon displayed on a computer desktop or a dashboard or activating a software program, such as a widget as provided by Apple, Inc.

In one embodiment, characteristics of an attractor 620 and/or repositioned arrays of content elements (e.g., arrays 615, 630, and 715) may be saved and/or archived in, for example, memory 225, main memory 215, a remote data store, such as data store 160, or on a remote server, such as server 130. In another embodiment, multiple pages including different arrays of repositioned content elements may be generated and/or stored.

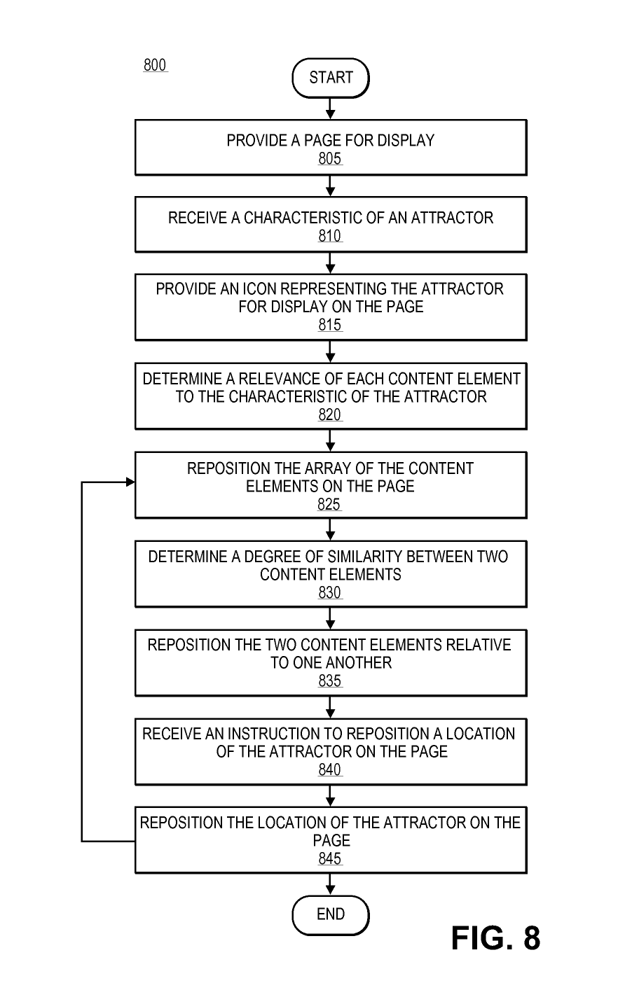

FIG. 8 is a flowchart illustrating an exemplary process 800 for visually representing a relative relevance of content elements to an attractor. Process 800 may be executed by, for example, any of the systems and/or system components described herein. Exemplary content elements include search results generated by, for example, a search engine, songs, files, messages, images, documents, contacts, jobs, candidates, matches provided by an online dating service, opportunities, news articles, products, service providers, locations, individuals, organizations, vendors, search results, email messages, messages received via a social networking service (e.g., Facebook™ or Twitter™), audio files, video files, files downloaded from the Internet, and/or any combination thereof.

In step 805, a page including an array of content elements may be provided for display on a video display, such as, video display 235 of computer system 110. In some embodiments, the page may resemble page 600, the array may resemble array 605, and the content elements may resemble content elements 610_{A-L} as discussed above with regard to FIG. 6. The content elements may be displayed on the page in any form, such as, for example, a graphic, an image, an alpha-numeric term, and/or an icon and in any type of array, including, but not limited to, a grid, a graph, a spiral, a tree, and an outline of a shape. The array of content elements may be displayed in two dimensions and/or three dimensions. One exemplary three-dimensional display of content elements includes a rotational display of a three-dimensional object (e.g., a cube or sphere) wherein a different content element is displayed on a different region of the surface area of the three-dimensional object (e.g., a side of a cube or hemisphere of a sphere). Another exemplary three-dimensional display of content elements includes a three-dimensional stack of content elements wherein different content elements appear to be stacked on top of one another in a three-dimensional manner. A further example of a three-dimensional display of content elements includes an increase in a size of a content element as displayed on a page when the content element is selected by a user so that the selected content element appears to come out of the page toward the user.

In step 810, a characteristic of an attractor may be received from, for example, user 105 via, for example, computer system 110. In some embodiments, the characteristic may be received via an interface, such as interface pages 300-500 as discussed above with regard to FIGS. 3-5. Exemplary characteristics include a search request, an attribute, a name, a term, a date, a type of content element, a file extension, a search term, an employment qualification, a personal quality, a Boolean search term, and a binary search term. A characteristic may act to attract and/or repel content elements. For example, a characteristic of an attractor may be to attract content elements regarding Paris, France and another characteristic of the attractor may be to repel content elements regarding Paris, Tex. In another example, a characteristic of an attractor may be to attract content elements regarding word processing programs and another characteristic of the attractor may be to repel content elements regarding Microsoft™.

In some instances, a plurality of characteristics for an attractor may be received. In these instances, one or more of the characteristics may be prioritized such that one or more of the received characteristics is deemed more important then another of the plurality of characteristics when applied to content elements. Prioritization may performed according to, for example, user configured parameters and/or default parameters (e.g., most recent prioritized first).

Next, in step 815, an icon representing the attractor may be provided for display on the page. The icon may be of any shape, size, or color and, in some instances, may be indicative of one or more characteristics associated with the attractor it represents. For example, an attractor associated with dogs may be displayed on the page as a dog icon.

Then, a relevance of each content element to one or more characteristics of the attractor may be determined (step 820). The relevancy determination of step 820 may be performed by any conventional means such as text normalization, matching, plain language analysis, and comparing a characteristic associated with the content element and a characteristic associated with the attractor. In some embodiments, the relevancy determination may determine whether a characteristic of a content element is a direct match to a characteristic of the attractor. In other embodiments, the relevancy determination may be nuanced and may include, for example, determining a degree of relevance of a content element to an attractor and/or determining the relevancy of characteristics similar to and/or synonymous with those associated with the content element and/or attractor.

Next, in step 825, the attractor may be applied to the content elements and the content elements included in the array may be repositioned according to, for example, their respective determined relevance to the attractor. For example, content elements determined to be highly relevant to the attractor may be repositioned within the array so that a relative distance or vector between the attractor and the highly relevant content elements is small. An example of positioning highly relevant content elements relatively close to an attractor is provided by content elements 610_{E}, 610_{J}, and 610_{H} of array 615 as shown in FIG. 6B. Likewise, the relative distance or vector between a moderately relevant content element and an attractor may be somewhat larger than the relative distance or vector between a highly relevant content element and an attractor. Exemplary moderately or indirectly relevant content elements are provided by content elements 610_{A}, 610_{D}, 610_{c}, 610_{D}, 610_{F}, and 610_{K} of array 615 as shown in FIG. 6B.

In some embodiments, the attractor may act to repel content elements that have little or no relevance to a characteristic of the attractor and/or are specifically repelled by a characteristic of the attractor. Content elements 610_{G} and 610_{L} are examples of content elements that may be repelled by an attractor. In one embodiment, the attractor may change an visual attribute of a content element (e.g., color, size, and/or shape) responsively to the determined relevance of the respective content element.

Optionally, in step 830, a degree of similarity between two or more content elements within the array displayed on the page may be determined and the two or more content elements may be repositioned (step 835) relative to, for example, one another and/or the attractor based on the determined degree of similarity between the two or more content elements. In some cases, when, for example, the two or more content elements have a threshold degree of similarity with one another, they may be repositioned such that a first content element is partially superimposed over a second content element. The two superimposed content elements may be displayed in a two-dimensional and/or three-dimensional manner so that, for example, the first content element partially obscures the second content element in a layered, or stacked, fashion. An example of two superimposed content elements displayed in a two-dimensional manner is provided by content elements 610_{F} and 610_{K} of FIG. 6B.

In another embodiment, an instruction to reposition a location of the attractor on the page may be received by, for example, computer system 110 from, for example, a user, such as user 105 (step 840). The location of the attractor on the page may then be repositioned on the page according to the received instruction (step 845). Following step 845, the content elements may be repositioned (step 825). Following steps 825, 835, and/or 845 process 800 may end.

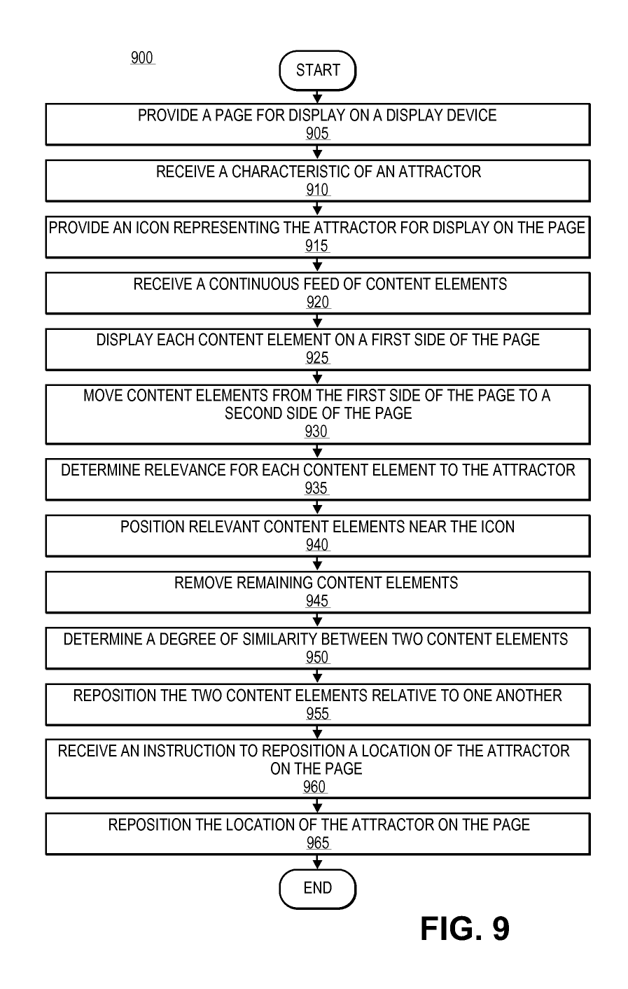

FIG. 9 is a flowchart illustrating an exemplary process 900 for visually representing the relative relevance of content elements included in a feed or continuous stream of content elements to an attractor. Process 900 may be executed by, for example, any of the systems and/or system components described herein.

In step 905 a page, such as, for example, page 700 as discussed above with regard to FIG. 7A, may be provided for display on a display device such as video display 235 of computer system 110. A characteristic of an attractor may be received (step 910) and icon representing the attractor may be provided for display on the page (step 915). An example of an icon representing the attractor is provided by attractor icon 620 as shown in FIG. 7B. In some cases, execution of steps 910-915 may resemble execution of steps 805-815 as discussed above with regard to FIG. 8.

Next, in step 920, a feed of content elements may be received by, for example, computer system 110. A feed of content elements may be, for example, any continuously and/or contemporaneously received stream of content elements. Exemplary feeds include a news feed, a social media feed (e.g., Facebook™ or Twitter™), an email feed, and a financial information feed (e.g., stock prices or options trading).

When a content element is received, it may be displayed, in part or in whole, on at first location on the page (step 925) and then moved, over time, from the first location on the page to a second location on the page in, for example, a ticker tape or flowing-stream-like fashion (step 930) as shown in, for example, page 700 as discussed above with regard to FIG. 7. In some cases, a portion of a content element may be displayed at the first location on the page and the portion of the content element displayed may increase with time as the content element moves from the first location on the page to the second location on the page. Typically, multiple content elements may be displayed on the page, although, on some occasions (e.g., when no other content elements are received via the stream/feed), only one content element may be displayed on the page. On some occasions, data associated with a content element may be abbreviated such that only information representative of the content element (e.g., a caption, summary, or heading) is displayed. The representative information displayed for a content element may be, for example, user configurable and/or set by default. Content elements may move from the first location to the second location in any manner, such as from left to right, from top to bottom, and/or change in size as the content elements moves from the first location to the second location (e.g., decreasing in size so that the content element appears to recede into the page).

While content elements are moving across the page, and/or prior to display of a content element, a relevance of each content element to the attractor may be determined (step 935). In some cases, execution of step 935 may resemble execution of step 820 as discussed above with regard to FIG. 8.

Next, in step 940, content elements with a threshold degree of relevance to the attractor may be positioned on the page near the icon representing the attractor and, on some occasions, may be removed from the continuous feed of content elements moving to the second location on the page. In one embodiment, content elements with a threshold degree of relevance may move past the attractor and then turn around and move back toward the attractor in a manner similar to, for example, a fish travelling in a school of fish and turning around. Examples of content elements with a threshold degree of relevance to the attractor are content elements 710_{A}, 710_{F}, 710ⱼ, and 710_{G} as discussed above with regard to FIG. 7A. Content elements with a threshold degree of relevance may be arranged in any manner around the attractor icon. In some cases, a relative distance or vector between the attractor icon and the content element may indicate the degree of relevance for the particular content element to the attractor such that the most relevant content elements are positioned closest to the attractor on the page. Content elements that do not have a threshold degree of relevance to the attractor may, for example, continue to move across the page to the second location on the page and may eventually be removed from the array/stream of content elements moving across the page (step 945).

Optionally, a degree of similarity between two or more content elements may be determined (step 950) and the two or more content elements may be repositioned relative to one another based upon their determined degree of similarity (step 955). For example, two content elements that are determined to be the same and/or substantially similar may be repositioned so that they partially superimpose one another. The two superimposed content elements may be displayed in a two-dimensional and/or three-dimensional manner such that one content element partially obscures the other content element in a layered, or stacked, fashion. An example of two superimposed content elements displayed in a two-dimensional manner is provided by content elements 710_{F} and 710ⱼ as shown in array 715 of FIG. 7B.

In another embodiment, an instruction to reposition a location of the attractor on the page may be received by, for example, computer system 110 from, for example, a user, such as user 105 (step 960). The location of the attractor on the page may then be repositioned according to the received instruction (step 965). Following steps 945, 955, and/or 965 process 900 may end.

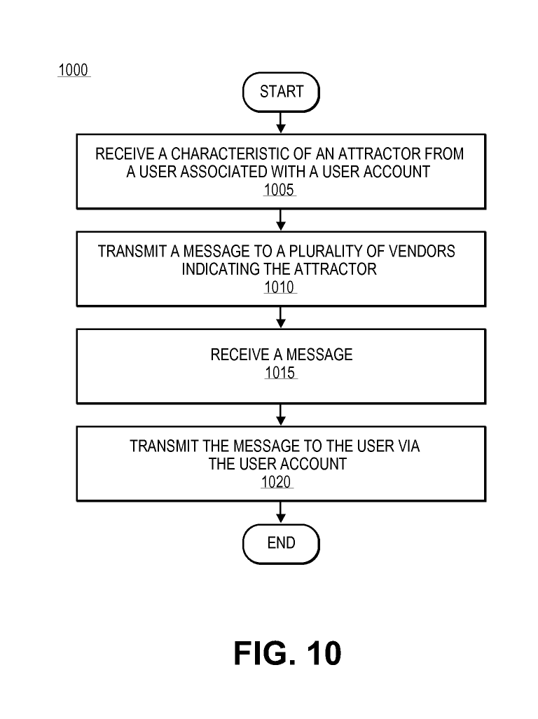

FIG. 10 is a flowchart illustrating an exemplary process 1000 for transmitting messages and/or advertisements to a user, such as user 105. Process 1000 may be executed by, for example, any of the systems and/or system components described herein.

In step 1005, a characteristic of an attractor may be received from a user associated with a user account, such as user 105. On some occasions, the characteristic of the attractor may indicate, for example, an item, good, and/or service the user is searching for and/or desires to purchase. The user account may be, for example, a user website, e-mail account, blog, a social media account, and/or customer account. In some embodiments, execution of step 1005 may be similar to execution of steps 810 and/or 910 as discussed above with regard to FIGS. 8 and 9, respectively.

Then, in step 1010, a message, indicating the attractor, may be transmitted to, for example, a plurality of vendor systems, like vendor system 150, individuals, and/or organizations. On some occasions, the attractor may be transmitted to vendor systems, individuals, and/or organizations regardless of the characteristic associated with the attractor while, on other occasions, the attractor may be transmitted only to a target group of vendor systems, individuals, and/or organizations with particular interest in the characteristic of the attractor.

In at least one embodiment, the message may include a user attribute. The user attribute may include information, for example, directly entered into the user account or used to create the attractor and/or may be passively gathered information. An example of information entered directly into a user account includes a name, an age, and a username. Exemplary passively gathered information includes a user's IP address, geographic location, average time spent online, online history, income level, credit history, and purchase history.

Next, in step 1015, a message may be received by, for example, computer system 110 from one of the vendor systems, individuals, and/or organizations via, for example, a server, like server 130. Exemplary messages include advertisements, special promotions, coupons, invitations, and recall notices. On some occasions, the message may be related to the attractor. The message may then be transmitted to the user (step 1020) for display on, for example, a video display like video display 235 and process 1000 may end.

The following is an example of the execution of process 1000. When a received characteristic of the attractor indicates that a user is interested in purchasing a new car a message indicating this interest may be transmitted to a plurality of vendor systems, individuals, and/or organizations and in some cases may only be transmitted to a group of targeted vendors, individuals, and/or organizations such as new car dealerships, and financial organizations offering loans for the purchase of a car. A message that may be directly, or indirectly, related to the attractor may then be received from a vendor system, individual, and/or organization (or associated ad server, etc.) that received the message. The message may be related to the attractor, such as a message related to a new car or new car financing. In some cases, a vendor system, individual, and/or organization may select a message that is related to a user attribute and may select a message so that it aligns with the user's attributes, such as income or lifestyle. For example, if a user attribute indicates that a user has an annual income of $60,000 a vendor system, individual, and/or organization of new cars may select a message directed to cars priced under $25,000. This message may then be transmitted to the user.

Thus, methods, systems, computer-readable media, and apparatus for visually displaying content elements have been herein described.

What is claimed is:

1. A method comprising:
displaying a page on a display device of a processor-based apparatus, said display device being communicatively coupled to a processor of said apparatus, the page including a number of visual representations of content elements;
responsive to receipt of user input specifying a characteristic of an attractor, determining, by the processor, a relevance of each content element to the characteristic of the attractor; and
displaying on the page a visual representation of the attractor and repositioning the visual representations of the content elements displayed on the page such that a relative vector between the visual representation of the attractor and the visual representation of each content element is related to the determined relevance of each respective content element.

2. The method of claim 1, wherein the relative vector between the visual representation of the attractor and the visual representations of each content element is proportional to the determined relevance of each respective content element.

3. The method of claim 1, wherein the visual representation of the attractor is an icon.

4. The method of claim 1, wherein various ones of the content elements represent at least one of a search result, a contact, a news article, a job, a candidate, an opportunity, an alert, a match provided by an online dating service, an e-mail, a message, a product, a service provider, a location, an individual, an organization, and a vendor.

5. The method of claim 1, wherein the characteristic is at least one of a search request, an attribute, an employment qualification, a personal quality, a name, a term, a date, a type of content element, a file extension, a search term, a Boolean search term, and a binary search term.

6. The method of claim 1, wherein the display device is enabled to directly receive the user input, and the method further comprises the processor receiving an instruction via a user interaction with the display device, and executing the instruction.

7. The method of claim 1, wherein the relative vector further accounts for a degree of similarity between characteristics of different ones of the content elements.

8. The method of claim 7, wherein when characteristics of at least two content elements have a threshold degree of similarity, the at least two content elements are displayed on the page at least partially superimposed on one another.

9. The method of claim 7, wherein when characteristics of at least two content elements have a threshold degree of similarity, the visual representation of the at least two content elements are displayed on a different region of a surface area of a three-dimensional object.

10. The method of claim 1, wherein the visual representations of the content elements are displayed as at least one of a graphic, an image, an alphanumeric term, and an icon.

11. The method of claim 1, wherein the page is displayed as a three-dimensional page and the relative vector between the visual representation of the attractor and the visual representations of the content elements is represented in at least one of two Cartesian dimensions and three Cartesian dimensions.

12. The method of claim 1, wherein in response to receipt of an instruction to reposition a location of the visual representation of the attractor on the page, the processor determines updates to each relative vector and as the location of the visual representation of the attractor on the page is changed, issues instructions to likewise update the locations of the visual representations of the content elements on the page according to updated values of the relative vectors therefor.

13. The method of claim 1, wherein the content elements are provided for display on the page by a content element provider, and the visual representations of the content elements are displayed only upon receipt of an indication that the content element provider has determined that the user has sufficient subscription rights to view the content elements.

14. The method of claim 13, wherein in the event no indication that the content element provider has determined that the user has sufficient subscription rights to view the content elements has been received, displaying an interface configured to permit the user to acquire subscription rights sufficient to view the content elements.

15. The method of claim 1, wherein the user input specifying a characteristic of an attractor is received via the user performing at least one of purchasing access to the characteristic, accessing the characteristic via a remote server, downloading the characteristic, and associating the characteristic with the attractor via an attractor generation process.

16. The method of claim 1, further comprising:
responsive to receipt of user input specifying a characteristic of an additional attractor, determining, by the processor, a relevance of each content element to the characteristic of the additional attractor; and
displaying on the page a visual representation of the additional attractor and repositioning the visual representations of the content elements displayed on the page such that a relative vector between the visual representations both of the attractors and the visual representation of each content element is related to the determined relevance of each respective content element.

17. A method comprising:
receiving, by a processor of a processor-based apparatus, a continuous feed of content elements from a server;
responsive to receipt of user input specifying a characteristic of an attractor, determining, by the processor, a relevance of each content element to the characteristic of the attractor;
displaying a page on a display device of the processor-based apparatus, said display device being communicatively coupled to the processor, the page including a visual representation of each content element included in the continuous feed on at first location on the page when the respective content element is received and a visual representation of the attractor;
moving, over time, the visual representation of each content element included in the continuous feed of content elements from the first location on the page to a second location on the page by the processor, wherein visual representations of content elements with a threshold degree of relevance to the characteristic of the attractor are positioned on the page near the visual representation of the attractor and removed from the continuous feed of content elements moving to the second location on the page; and
removing, by the processor, the visual representation of each content element not positioned near the visual representation of attractor from the page when it reaches the second location on the page.

18. The method of claim 17, wherein the visual representation of the attractor is an icon.

19. The method of claim 17, wherein the characteristic is at least one of a search request, an attribute, a name, a term, a date, a type of content element, a file extension, a search term, an employment qualification, an alert, a news item, a personal quality, a Boolean search term, and a binary search term.

20. The method of claim 17, wherein the display device is enabled to directly receive the user input, and the method further comprises the processor receiving an instruction via a user interaction with the display device and executing the instruction.

21. The method of claim 17, wherein the relative vector further accounts for a degree of similarity between characteristics of different ones of the content elements.

22. The method of claim 21, wherein when characteristics of at least two content elements have a threshold degree of similarity, the visual representation of the at least two content elements are displayed on the page at least partially superimposed on one another.

23. The method of claim 21, wherein when characteristics of at least two content elements have a threshold degree of similarity, the visual representation of the at least two content elements are displayed on a different region of a surface area of a three-dimensional object.

24. The method of claim 17, where in the visual representation of the content elements are displayed as at least one of a graphic, an image, an alphanumeric term, and an icon.

25. The method of claim 17, wherein the page is displayed as a three-dimensional page and the relative vector between the visual representation of the attractor and the visual representation of the content element is displayed in at least one of two Cartesian dimensions and three Cartesian dimensions.

26. The method of claim 17, wherein the size of the visual representation of the content element changes over time.

27. The method of claim 17, wherein in response to receipt of an instruction to reposition a location on the visual representation of the attractor on the page, the processor determines updates to each relative vector and as the location on the visual representation of the attractor on the page is changed, issues instructions to likewise update the locations of the visual representation of the content elements on the page according to updated values of the relative vectors therefor.

28. A method comprising:
receiving, by a server, a characteristic of an attractor from a user associated with a user account;
transmitting, by the server, a message to a plurality of vendors indicating the attractor;
receiving, by the server, a message related to the characteristic of the attractor from at least one of the plurality of vendors; and
transmitting, by the server, the message to the user via user account.

29. A non-transitory computer-readable media including a set of instructions which instructions when executed by said processor, cause said processor to:
display a page on a display device of a processor-based apparatus, said display device being communicatively coupled to a processor of said apparatus, the page including a visual representation of a number of content elements;
determine a relevance of each content element to a characteristic of an attractor responsively to received user input specifying the characteristic of the attractor;
display on the page a visual representation of the attractor; and
reposition the visual representation of the content elements displayed on the page such that a relative vector between the visual representation of the attractor and the visual representation of each content element is related to the determined relevance of each respective content element.

30. A computer system, comprising a processor, a display device communicatively coupled to the processor, and a computer-readable storage medium communicatively coupled to the processor, said storage medium having stored therein computer-readable instructions, which instructions when executed by said processor, cause said processor to display on the display device visual representations of content elements received by the computer system in an organized relation to a visual display of an attractor displayed on the display device at a position subject to user manipulation through a human-computer interface communicatively coupled to the processor, said organized relation defined by a relevance of an attribute of the content elements to a characteristic of the attractor.
